(19) United States
(12) Patent Application Publication
(10) Pub. No.: US 2003/0103008 A1
(43) Pub. Date: Jun. 5, 2003

(54) In-building low profile antenna

(76) Inventors: Tom Petropoulos, Mt. Prospect, IL (US); Steve Zeilinger, Carol Stream, IL (US)

Correspondence Address: Welsh & Katz, Ltd., Jon P. Christensen, 22nd Floor, 120 South Riverside Plaza, Chicago, IL, 60606, US

(21) Appl. No.: 10/010,838

(22) Filed: Dec. 5, 2001

(51) Int. Cl. H01Q 1/24

(52) U.S. Cl. 343/702; 343/846

(57) ABSTRACT

A method and apparatus are provided for transceiving signals in multiple frequency bands. The apparatus includes a ground plane and a radiating structure coupled to said ground plane. The radiating structure further includes a primary radiator having a predetermined first resonant frequency band and a sheet conductor coupled to said primary radiator and spaced from said ground plane, said sheet conductor being so configured as to cause said radiating structure to have a second predetermined resonant frequency band.

### FIELD OF THE INVENTION

The field of the invention relates to wireless communications and more particularly to antennas used for wireless communications.

### BACKGROUND OF THE INVENTION

The continued evolution of consumer wireless devices has led to a variety of offered services and devices for providing those services. Cellular telephones that were originally practical for use only in motor vehicles have become smaller, lighter and more portable to the point that they may now be easily carried in a shirt pocket or purse.

Further, the communications link provided by the cellular telephone has spawned the development of a number of ancillary wireless services and devices for providing those services. Examples of such services include palm pilots and personal data assistants (PDAs).

As the need of cellular devices has grown, the availability and size of the radio frequency spectrum for servicing that need has also grown in both the U.S. and abroad. For example, the narrowband analog mobile phone service (NAMPS), predominantly used in the U.S., operates in a frequency range of from 824 MHz to 894 MHz. The corresponding Europeans standard (GSM) operates in the range of from 872 MHz to 960 MHz. Personal communication services (PCS) operating with the personal communication network (PCN) and JTACS (used in Japan) operate in the range of from 1.4 GHz to 2.3 GHz.

Another recent development in wireless devices has been the availability to consumers of portable global positioning system (GPS) devices. GPS devices are designed to detect signals from a constellation of satellites maintained by the U.S. Department of Defense and to provide accurate positioning information to within a few hundred feet. GPS receivers typically operate at frequencies of 1227.6 MHz and 1575.42 MHz.

While wireless devices have become an integral part of life for many people, the need to subscribe to more than one service often requires a consumer to carry a number of devices. While progress has been made at combining some of these devices, the frequencies at which such devices operate has made it difficult to provide the antennas necessary for operation. Because of the importance of wireless devices, a need exits for an antenna which is capable of operating over multiple frequency ranges.

### BRIEF DESCRIPTION OF THE DRAWINGS

FIG. 1 depicts a perspective view of a multiband antenna that may be used to transceive signals under an illustrated embodiment of the invention;

FIG. 2 depicts a cut-away view of a portion of the antenna of FIG. 1;

FIG. 3 depicts a considerably simplified equivalent of a portion of the antenna of FIG. 1;

FIG. 4 depicts a considerably simplified equivalent of a portion of the antenna of FIG. 1;

FIG. 5 depicts an equivalent circuit of the antenna of FIG. 1 at low band;

FIG. 6 depicts a schematic of the equivalent circuit of FIG. 5;

FIG. 7 depicts a resonant circuit coupled to the antenna of FIG. 3;

FIG. 8 depicts a simplified equivalent circuit of the circuit of FIG. 7;

FIG. 9 depicts a radiation azimuth diagram of the low frequency portion of the antenna of FIG. 1;

FIG. 10 depicts a radiation elevation diagram of the high frequency portion of the antenna of FIG. 1;

FIGS. 11a-b depicts a phase diagram and standing wave ratios over the operating frequencies of the antenna of FIG. 1; and

FIG. 12 depicts an alternate embodiment of the antenna of FIG. 1.

### DETAILED DESCRIPTION OF AN ILLUSTRATED EMBODIMENT

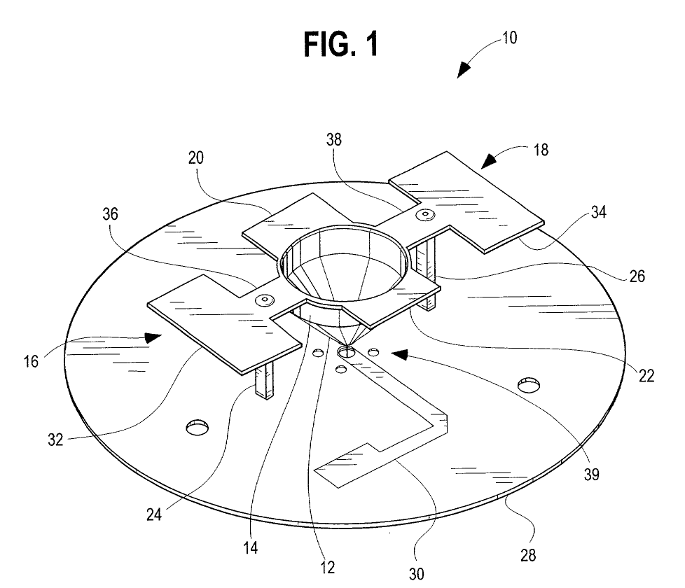

FIG. 1 is a perspective view of a dual/triple band antenna 10, shown generally under an illustrated embodiment of the invention. The antenna 10 may be fabricated as a single unitary transceiving device from a relatively thin (e.g., 0.38 mm) sheet of an appropriate conductive material (e.g., hard C260 Brass). The antenna 10 may find its best use inside of a building disposed on a ceiling.

As shown in FIG. 1, the antenna 10 may include a number of functionally discrete portions or subsections. While the sections are functionally discrete, it may be observed that the sections, in fact, mechanically and functionally overlap, as discussed in more detail below.

For example, the antenna 10 may include a number of mechanically discrete elements. The mechanically discrete elements may include a primary radiator including a conical center section 12 and cone extension 14, a first set of sheet conductors 16, 18, a second set of conductive surfaces (sheet conductors) 20, 22, cylindrical conductors 24, 26, ground plane 28 and signal lead 30 for conducting a signal to and from the antenna 10.

Further, the antenna 10 may operate simultaneously on different frequency bands. The entire antenna 10 of FIG. 1 may operate on a first relatively low frequency band, while the cone 12 simultaneously operates on a second relatively high frequency band.

In general, the cone 12, by itself, may operate as a monopole antenna with a relatively broadband response. The cone 12 is vertically polarized and radiates towards the horizon. The length L1 (FIG. 2) may be regarded as a determinate of the lower frequency limit of operation of the cone 12. The lower frequency limit may have a wavelength about four times the length L1 (i.e., the length L1 is ¼ wavelength of the lowest operating frequency).

The antenna 12 of FIG. 2 also resonates at higher frequencies where a smaller portion of the antenna 12 is active (i.e., active area<L1). An upper frequency limit may be determined by the feedpoint geometry of the apex of the cone 12. For the cone 12 of FIG. 1, the upper limit may be somewhere around 4 GHz.

In general, the high frequency section (i.e., the cone 12 and extension 14) may be fabricated to operate in the PCN/PCS frequency band of from 1700 MHz to 3000 MHz. It may also be observed that a monopole antenna fabricated to operate in this frequency range could also be used for universal mobile telecommunications service (UMTS) which operates in the range of from 1885 to 2025 MHz.

From a physical point of view, the cone 12 may be structured as a hollow shell in the form of an inverted cone with a flared end and open top. A top end surface may be defined by the divergent edges of the inverted hollow shell of the cone. The top end surface may have a relatively large diameter (e.g., 39.2 mm). A truncated bottom, formed near the apex of the cone, may have a relatively small diameter (e.g., 1.2 mm). The sides may taper inwards from top to bottom by an appropriately steep angle (e.g., 46 degrees from vertical) and have a total height adapted to the operating frequency (e.g., 17.4 mm).

The cone 12 and cone extension 14 may also form a portion of another relatively low frequency antenna in the NAMPS/GSM bands (e.g., from 806 MHz to 970 MHz). Conductive surfaces 16, 18, 20, 22 may be disposed parallel to the ground plane 28 and act as capacitors against the ground plane 28.

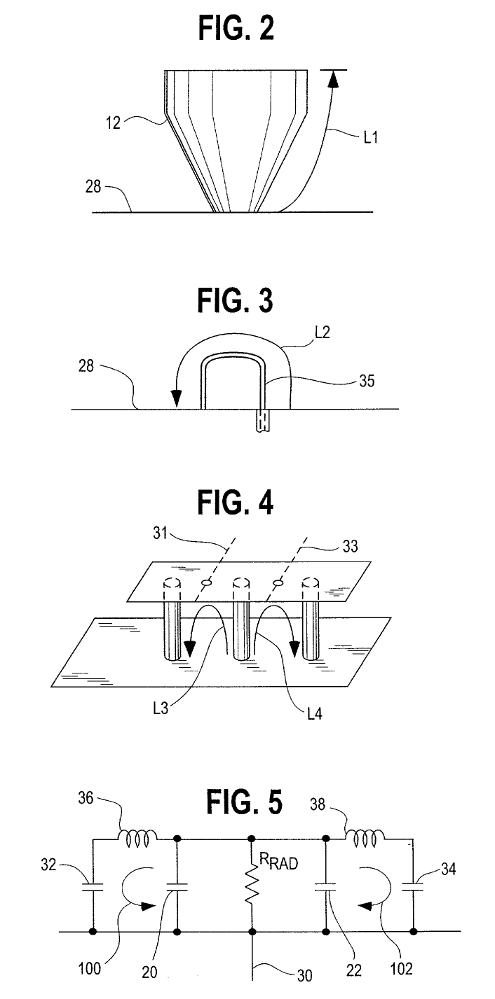

In general, opposing ends of the antenna 10 of FIG. 1 may have characteristics similar to the loop antenna 35 shown in FIG. 3. The resonance frequency of each loop 35 formed by the antenna 10 may have a wavelength equal to twice the length L2 of FIG. 3.

The antenna 10 of FIG. 1 may also have characteristics of the center-fed T-antenna shown in FIG. 4. In general, the T-antenna of FIG. 4 would resonate at a wavelength equal to twice the paths defined by paths L3 and L4.

Further, a set of points 31, 33 may be defined along paths L3 and L4 of the T-antenna. The T-antenna of FIG. 4 may also resonate at a much higher frequency defined by the distance of paths L3 and L4 because points 31, 33 would appear as open circuit at that frequency. At that frequency, the T-antenna of FIG. 4 virtually degenerates into a conical monopole antenna.

The overall characteristics of the antenna 10 of FIG. 1 differs from the loop antenna of FIG. 2 and T-antenna of FIG. 4 in a number of regards. For example, the conductive surfaces 16, 18 may divided into first elements 32, 34 whose contribution is primarily capacitive and second elements 36, 38 whose function is both capacitive and inductive. Connector elements 36, 38 may function as inductive elements connecting the cone extender to the capacitive elements 32, 34.

In general, it has been found that feeding a narrow strip 36, 38 from a broad strip (e.g., the cone 12) creates an inductance. The combination of the inductive elements 36, 38 and capacitive strips 32, 34 function to reduce the effective size of the antenna 10 while contributing to a significantly broader frequency range.

FIG. 5 depicts an equivalent circuit formed by the antenna 10 at low band. As shown, a transmit/receive signal lead 30 couples energy to/from the antenna 10. When transceiving a signal in the high frequency band, the cone 12 functions independently of the remainder of the equivalent circuit.

When operating in the low frequency band, a first and second loop circuit 100, 102 comes into play, increasing the radiation resistance R_{RAD} significantly. The radiation resistance is analogous to N², where N is the number of loops. As shown by the equivalent circuit of FIG. 5, the first and second loop circuits 100, 102 form resonators fed in the low frequency ranges by the cone 12. The increased radiation resistance coupled with the relatively large surface area of the antenna 10 functions to provide an antenna with significantly improved multiband operating characteristics. It should be noted that while FIG. 5 may be instructive of operation of the antenna 10, the actual model that represents the antenna is more complicated.

For example, it has been found that the interaction between the cone 12, cone extension 14 and conductive elements 16, 18, and cylindrical conductors 24, 26 produces a resonance within a first range of frequencies. It has also been found that the interaction between the cone 12, cone extension 14 and conductive elements 20, 22 produces resonance within a second range of frequencies.

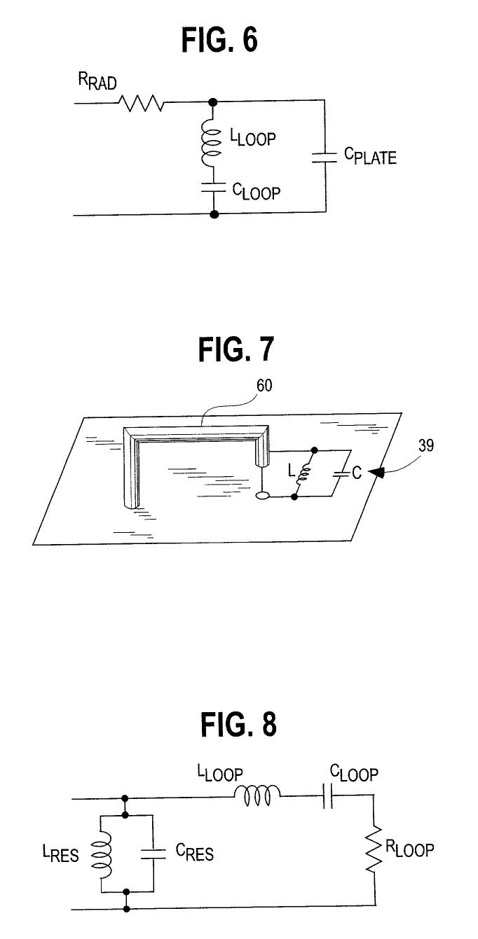

FIG. 6 depicts an equivalent circuit of the antenna 10 of FIG. 1, where L_{LOOP} and C_{LOOP} are the distributed inductance and capacitance of each loop, R_{RAD} is the radiation resistance and C_{PLATE} is the capacitance of the plates 32, 34, 36, 38. C_{PLATE} functions to reduce the overall resonant frequency (i.e., for specified dimensions, the antenna 10 operates over a lower frequency range). The capacitance of the plates functions to reduce the height of the antenna.

To further expand the bandwidth of the low frequency antenna 10, a resonator 39 may be provided coupled between the apex of the cone 12 and the signal line 30. FIG. 7 provides an example schematic of the use of the resonator 39 with a loop antenna such as that shown in FIG. 3. FIG. 8 is a schematic diagram of the resonator 39 in the context of use with the antenna of FIG. 7, where L_{LOOP}, C_{LOOP} and R_{LOOP} are distributed values of the loop of FIG. 7 and L_{RES} and C_{RES} are the inductance and capacitance of the resonator, respectively.

In general, a resonator 39 located at the feedpoint of the cone 12 resonates at approximately the same frequency as an equivalent loop of the antenna 10 and broadens the frequency response. The resonator 39 may be provided in the form of a microstrip open stub with a center frequency of 920 MHz. The length of the microstrip is about λ_{g}/2, where λ_{g} is the wavelength in the substrate at the center frequency of low band.

The second set of conductive surfaces 20, 22 may be provided in order to fine tune an impedance match between the antenna 10 and the signal lead 30 in a high frequency range. A front capacitive element 22 may extend outwards 30 mm from a centerline of the cone 12 and have a width of 30 mm. A rear capacitive element 20 may extend outwards 33 mm and also have a width of 30 mm. The rear capacitive element 20 may have a greater length than the front capacitive element 22 to broaden the response of the antenna 10. The elements 20, 22 function to match the antenna to the 50 ohm feed line.

The overall dimension between the outside edges of the longitudinal set of conductive surfaces 16, 18 may be 122 mm (i.e., from one end of the antenna 10 to the other end). The length of each capacitive element 32, 34 (along the axis passing through the center of the cone) may be 23.25 mm. Each element 32, 34 may be 46.2 mm wide.

Inductive elements 36, 38 may be coupled to the ground plane 28 through a set of conductive elements 24, 26. Conductive elements 24, 26 may have an overall length of 27.6 mm.

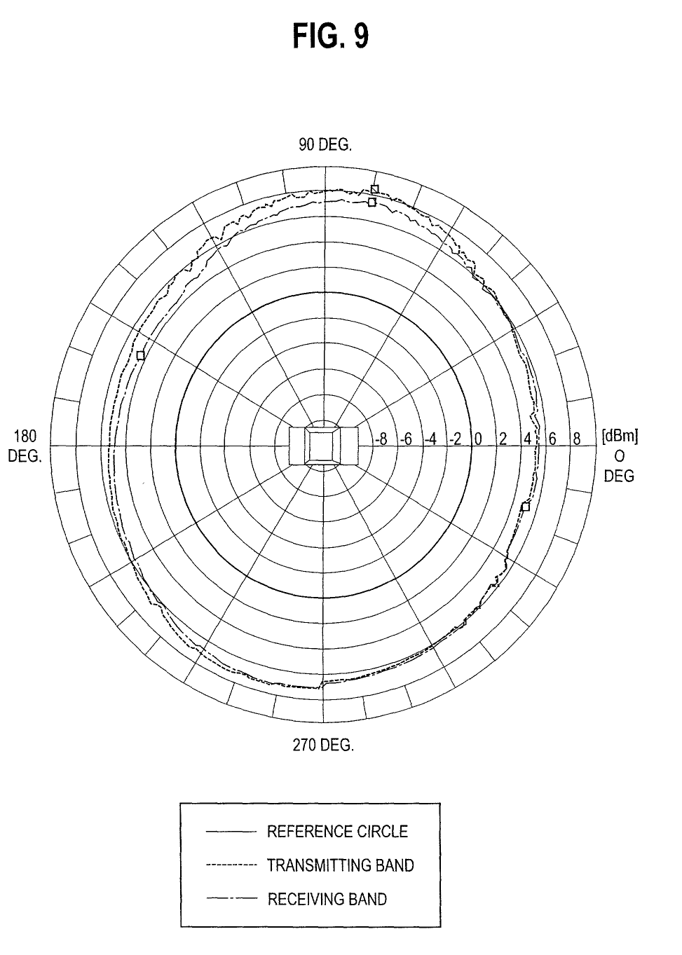

FIG. 9 shows a radiation azimuth diagram for the antenna 10 over a frequency range of from 850 MHz to 950 MHz. As may be noted from FIG. 9, the radiation pattern of the antenna 10 is relatively constant in all directions and shows very little deviation between a received and a transmitted signal.

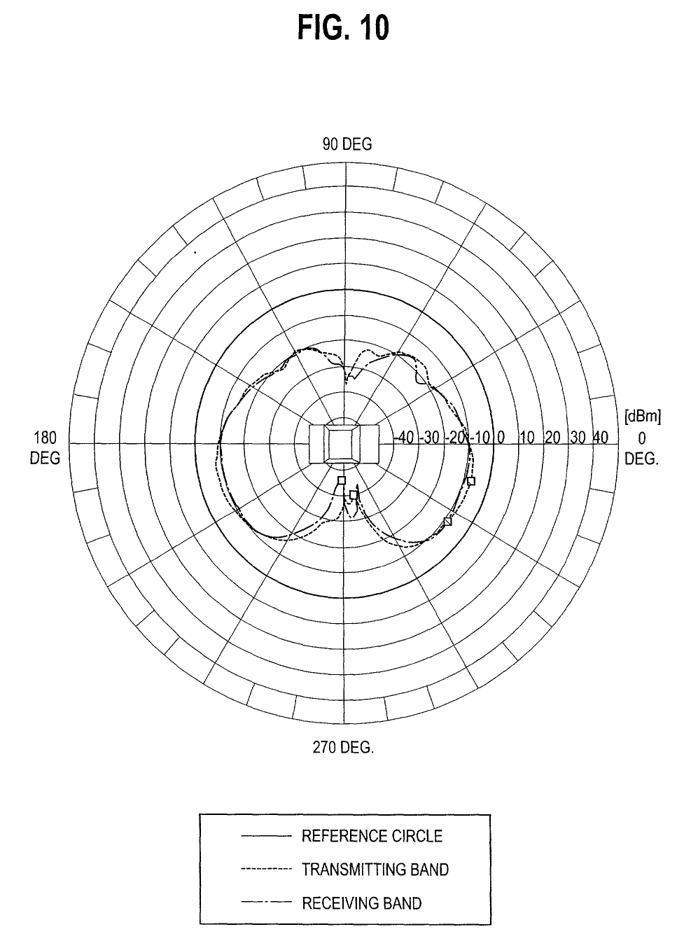

FIG. 10 shows a radiation elevation diagram for the antenna 10 over a frequency range of from 1900 MHz to 2200 MHz. As may be noted from FIG. 9, the radiation pattern is similar to a monopole above ground. However, as with the lower frequency range, the higher frequency range shows very little deviation between a received and a transmitted signal.

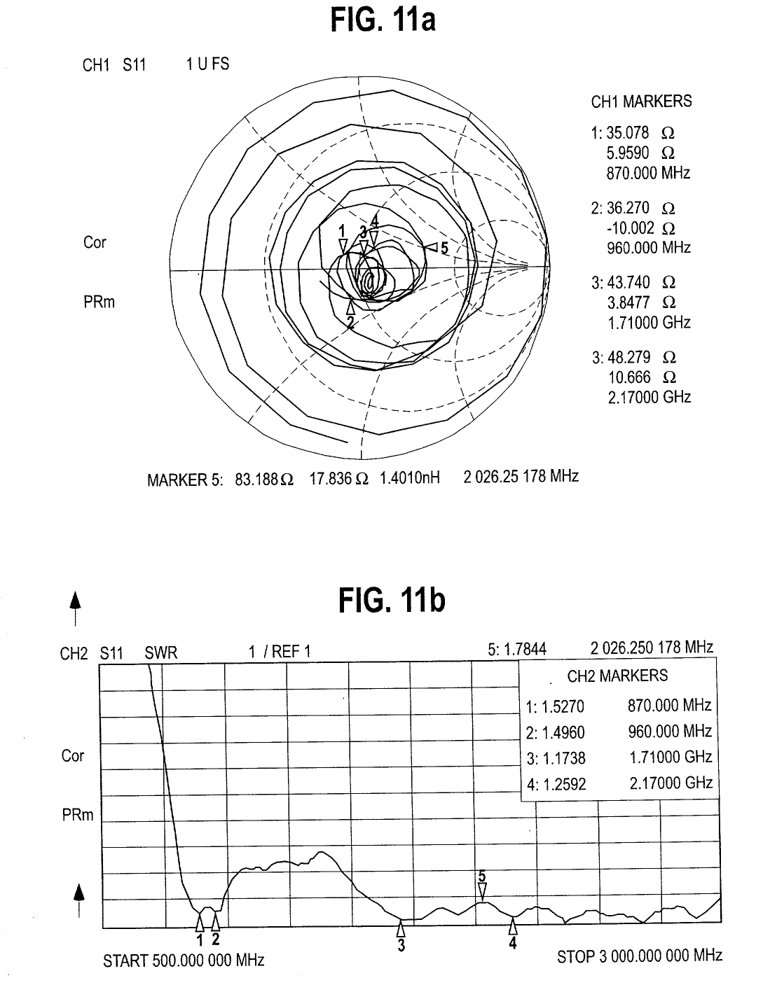

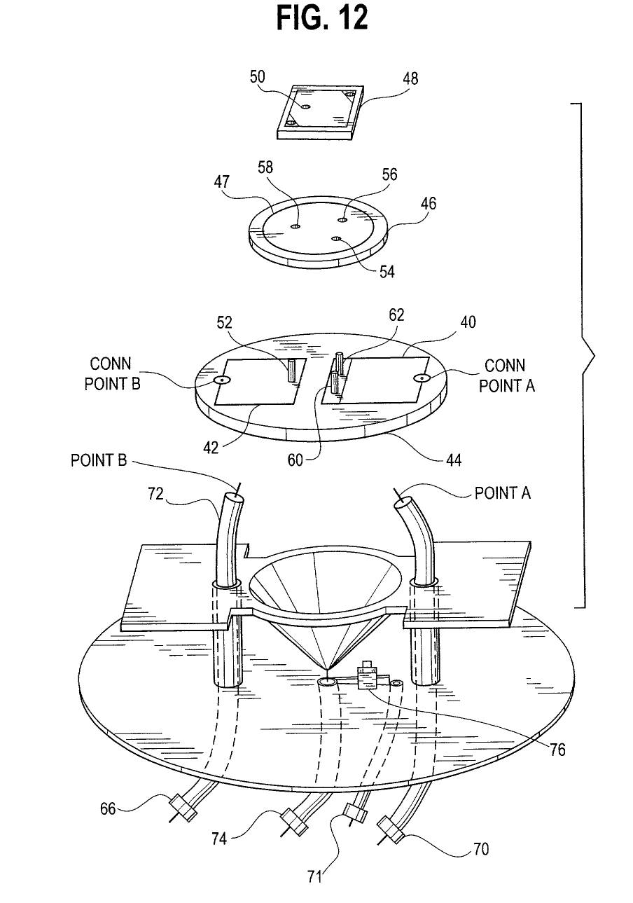

FIG. 11a depicts an impedance diagram (Smith chart) and FIG. 11b shows a standing wave ratio (SWR) of the antenna 10 over the range of from 550 to 3000 MHz. As shown, the SWR is relatively constant and below 2 over the frequency ranges of use. The fact that the VSWR is below 2 at frequencies above 1.7 GHz is due to the fact that the antenna portion that is active at those frequencies is the conical portion, which is broadband.

To further enhance the usefulness of the antenna 10 of FIG. 1, the cone 12 may be top loaded, as shown in the exploded view of FIG. 12 with one more additional patch antenna directed to additional frequency bands. For example, a first patch antenna 46 may be provided for receiving a satellite digital audio radio (SDAR) signal. A second patch antenna 48, mounted directly on top of the SDAR antenna 46, may be provided for receiving a global positioning system (GPS) signal. The patch antenna are circularly polarized and radiate towards the satellites.

The GPS patch antenna 48 may be of appropriate dimension (e.g., 25×25 mm in a high dielectric substrate) for receiving GPS signals. The GPS antenna 48 may be disposed on a top surface of substrate 47 that is, in turn, disposed on top of the SDAR patch antenna 46.

A GPS signal from the GPS antenna 48 may be coupled from a connection point 50 to an low noise amplifier (LNA) 42 by conductor 52 passing through feedthrough holes 50, 58. A signal lead 72 may couple the detected GPS signals from connection point B of the LNA 42 through the cone extender 13, across a bottom surface of the connector 38 and through an inside cavity of the conductive elements 24 to an external antenna cable 66.

The SDAR patch antenna 46 may be of an appropriate size (e.g., 55 mm×55 mm in a low dielectric substrate) for receiving SDAR signals. The SDAR antenna 46, in turn, may be disposed on substrate 44. Substrate 44, in turn, may be supported by an upper edge of the cone 12.

An output of the SDAR antenna 46 may be conducted from a set of connection points 54, 56 to an SDAR amplifier 40 using feedthroughs 60, 62. A conductor 70 attached to connection point A on the amplifier 40 extend through the cone extender 13, across a bottom surface of the connector 38 and through an inside cavity of the conductive elements. A second connection 71 with the SDAR amplifier 40 is formed through a bandpass filter 76 and the cone 12.

A third set of conductors 74 may connect to the low frequency signal lead 30. Together, the external antenna cables 66, 70, 71, 74 provides connections to antenna structure capable of operating in five different frequency bands.

A specific embodiment of a method and apparatus for providing a multiband antenna has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A multiband antenna comprising:
a ground plane; and
a radiating structure coupled to said ground plane, said radiating structure further comprising:
a primary radiator having a predetermined first resonant frequency band; and
a sheet conductor coupled to said primary radiator and spaced from said ground plane, said sheet conductor being so configured as to cause said radiating structure to have a second predetermined resonant frequency band.

2. The antenna defined by claim 1 wherein said primary radiator further comprises a conical wideband omnidirectional radiator with a relatively high resonant frequency band.

3. The antenna defined by claim 2 wherein said second frequency band further comprises a spectral region lower than said first frequency band.

4. The antenna defined by claim 1 wherein said sheet conductor and said primary conductor further comprise a single sheet of electrically conductive metal.

5. The antenna defined by claim 4 wherein said primary radiator further comprises a conical wideband omnidirctional radiator having a relative high frequency band.

6. The antenna defined by claim 5 wherein said second resonant frequency band further comprises a spectral region lower than said first frequency band.

7. The antenna defined by claim 1 wherein said primary radiator further comprises a conical shape with a relatively narrow apex at the ground plane, and a flared end.

8. The antenna defined by claim 7 wherein said sheet conductor comprises a pattern of wide and narrow areas integral with the flared end of said primary radiator, said wide and narrow areas creating capacitive and inductive effects which determine the frequency characteristics of said second resonant frequency band.

9. The antenna defined by claim 8 wherein said sheet includes areas adapted to fine tune the frequency response of said radiating structure.

10. The antenna defined by claim 1 further comprising a conductive support coupling said sheet conductor to said ground plane, said support being hollow and adapted to pass a feed.

11. The antenna defined by claim 1 wherein the sheet conductor and ground plane further comprise parallel planar structures.

12. The antenna defined by claim 1 further comprising a resonator coupled between the primary resonator and ground.

13. The antenna defined by claim 12 wherein the resonator further comprises a tuned stub.

14. The antenna defined by claim 1 wherein the sheet conductor further comprises first and second sheet conductors on opposing sides of the primary radiator.

15. The antenna defined by claim 1 further comprising an impedance matching element coupled to the primary radiator.

16. The antenna defined by claim 1 further comprising a patch antenna adapted to top load the primary radiator.

17. The antenna defined by claim 16 wherein the patch antenna further comprises a satellite digital audio radio patch antenna.

18. The antenna defined by claim 17 wherein the patch antenna further comprises a global positioning system patch antenna.

19. The antenna defined by claim 16 wherein the patch antenna further comprises a global positing system patch antenna disposed on a satellite digital audio radio patch antenna.

20. The antenna defined by claim 16 wherein the satellite digital audio radio patch antenna further comprises a feedthrough for coupling a signal connection to the global positing system patch antenna.

21. A method of transceiving signals in multiple frequency bands, such method comprising the steps of:
providing a generally conical structure operating as an antenna to communicate signals over a first frequency range, said generally conical structure having an aperture defined by an end surface thereof;
forming first and second conductive surfaces coupled to said end surface and shaped to communicate signals over a second frequency range, said conductive surfaces being generally coplanar with the end surface;
providing a ground plane disposed in generally parallel spaced relationship relative to said conductive surfaces; and
forming at least two support structures coupled to said conductive surfaces, for supporting said conductive surfaces at a distance (d) from the ground plane.

22. The method of transceiving signals in multiple frequency bands as in claim 21 further comprising coupling a signal lead to an apex of the generally conical structure.

23. The method of transceiving signals in multiple frequency bands as in claim 21 further comprising coupling a resonator to an apex of the generally conical structure.

24. The method of transceiving signals in multiple frequency bands as in claim 21 where in the step of forming first and second conductive surfaces further comprises disposing the first and second conductive surfaces on opposing sides of the conical structure.

25. The method of transceiving signals in multiple frequency bands as in claim 21 further comprising forming third and fourth conductive surfaces coupled to said end surface.

26. The method of transceiving signals in multiple frequency bands as in claim 21 wherein the step of forming third and fourth conductive surfaces further comprises disposing the first and second conductive surfaces on opposing sides of the conical structure along an axis orthogonal to an axis passing through the first and second conductive surfaces.

27. The method of transceiving signals in multiple frequency bands as in claim 21 further comprising top loading the generally conical structure.

28. The method of transceiving signals in multiple frequency bands as in claim 27 wherein the step of top loading further comprises disposing a patch antenna above the end surface of the generally conical structure.

29. The method of transceiving signals in multiple frequency bands as in claim 27 wherein the step of disposing a patch antenna above the end surface of the generally conical structure further comprises structuring the patch antenna as a satellite digital audio radio patch antenna.

30. The method of transceiving signals in multiple frequency bands as in claim 29 wherein the step of disposing the patch antenna above the end surface of the generally conical structure further comprises structuring the patch antenna as a global positioning system patch antenna.

31. The method of transceiving signals in multiple frequency bands as in claim 30 wherein the step of disposing the patch antenna above the end surface of the generally conical structure further comprises disposing the satellite digital audio radio patch antenna between the global positioning patch antenna and the conical structure.

32. An apparatus for transceiving signals in multiple frequency bands, such apparatus comprising:
a generally conical structure adapted to operate as an antenna to communicate signals over a first frequency range, said generally conical structure having an aperture defined by an end surface thereof;
first and second conductive surfaces coupled to said end surface and shaped to communicate signals over a second frequency range, said conductive surfaces being generally coplanar with the end surface;
a ground plane disposed in generally parallel spaced relationship relative to said conductive surfaces; and
at least two support structures coupled to said conductive surfaces, for supporting said conductive surfaces at a distance (d) from the ground plane.

33. The apparatus for transceiving signals in multiple frequency bands as in claim 32 further comprising means for coupling a transceiver to an apex of the generally conical structure.

34. The apparatus for transceiving signals in multiple frequency bands as in claim 32 further comprising means for coupling a resonator to an apex of the generally conical structure.

35. The apparatus for transceiving signals in multiple frequency bands as in claim 32 wherein the first and second conductive surfaces further comprises the first and second conductive surfaces disposed on opposing sides of the conical structure.

36. The apparatus for transceiving signals in multiple frequency bands as in claim 32 further comprising third and fourth conductive surfaces coupled to said end surface.

37. The apparatus for transceiving signals in multiple frequency bands as in claim 32 wherein the third and fourth conductive surfaces further comprises the first and second conductive surfaces disposed on opposing sides of the conical structure along an axis orthogonal to an axis passing through the first and second conductive surfaces.

38. The apparatus for transceiving signals in multiple frequency bands as in claim 32 further comprising means for top loading the generally conical structure.

39. The apparatus for transceiving signals in multiple frequency bands as in claim 38 wherein the means for top loading further comprises a patch antenna disposed above the end surface of the generally conical structure.

40. The apparatus for transceiving signals in multiple frequency bands as in claim 39 wherein the a patch antenna further comprises a satellite digital audio radio patch antenna.

41. The apparatus for transceiving signals in multiple frequency bands as in claim 39 wherein the patch antenna further comprises a global positioning system patch antenna.

42. The apparatus for transceiving signals in multiple frequency bands as in claim 41 further comprising disposing the satellite digital audio radio patch antenna between the global positioning patch antenna and the conical structure.

43. An antenna operable to communicate signals in multiple frequency bands, said antenna comprising:
a generally conical structure operating as an antenna to communicate signals over a first frequency range, said generally conical structure having an aperture defined by an end surface thereof;
at least two conductive surfaces coupled to said end surface and shaped to communicate signals over a second frequency range, said conductive surfaces being generally coplanar with said end surface;
a ground plane disposed in generally parallel spaced relationship relative to said conductive surfaces; and
at least two support structures coupled to said conductive surfaces, for supporting said conductive surfaces at a distance (d) from said ground plane.
